(19) United States
(12) Patent Application Publication
(10) Pub. No.: US 2005/0241940 A1
(43) Pub. Date: Nov. 3, 2005

(54) Fast perfusion system and patch clamp technique utilizing an interface chamber system having high throughput and low volume requirements

(75) Inventors: Dmytro Vasylyovych Vasylyev, Hightstown, NJ (US); Mark Robert Bowlby, Richboro, PA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Wyeth, Madison, NJ (US)

(21) Appl. No.: 10/836,597

(22) Filed: May 3, 2004

(51) Int. Cl. G01N 27/27

(52) U.S. Cl. 204/450; 422/99; 204/600

(57) ABSTRACT

A system for carrying out fast perfusion for the patch clamp techniques useful in studying the effect of compounds on ion transfer channels in biological tissue is disclosed. The invention additionally includes microperfusion chamber assemblies capable of utilizing small amounts of material to be tested and small amounts of liquid carrier, thereby enabling multiple tests to be completed in a short period of time. The invention more broadly relates to an electrophysiology drug handling and application set up for screening chemicals such as drugs while providing high throughput and low volumes of solutions and samples.

### FIELD OF THE INVENTION

The invention relates to systems for carrying out fast perfusion and obtaining patch clamp recordings in a “blind patch” manner for the study of biological membranes and their integral membrane proteins. More particularly, this invention relates to patch clamp perfusion systems having high throughput and low volume requirements useful for electrophysiology drug handling and application set up for screening of chemicals such as drugs. The invention also provides an apparatus for high throughput screening and methods of using the same.

### BACKGROUND OF THE INVENTION

Many cellular processes are controlled by changes in cell membrane potential due to the action of carrier proteins and ion channels. Carrier proteins bind specific solutes and transfer them across the lipid bilayer of biological cell membranes by undergoing conformational changes that expose the solute binding site sequentially on one side of the membrane and then on the other. Some carrier proteins simply transport a single solute “downhill,” i.e., along its concentration and/or electrochemical gradient. Other carrier proteins can act as pumps to transport a solute “uphill” against its concentration and/or electrochemical gradient, using energy provided by ATP hydrolysis or by a “downhill” flow of another solute (such as sodium) to drive the requisite series of conformational changes (reviewed in B. Alberts et al., 1994, Molecular Biology of the Cell, 3rd ed, Garland Publishing, Inc., New York, N.Y.). Several carrier proteins, such as the superfamily of ABC transporters, are especially important clinically. These proteins are known to be responsible for cystic fibrosis, as well as for drug resistance in cancer cells and malaria-causing parasites.

Unlike carrier proteins, ion channel proteins are transmembrane proteins that form pores in biological membranes which allow ions and other molecules to pass from one side to the other. There are various types of ion channels. For instance, “leak channels” are open under all physiological membrane conditions. “Voltage-gated channels” open in response to electric potential across the membrane. “Ligand-gated channels” respond to the binding of specific molecules, such as extracellular mediators (e.g., neurotransmitters), or intracellular mediators (e.g., ions or nucleotides). Still other ion channels are modulated by interactions with proteins, such as G-proteins.

Ion channel proteins primarily mediate the permeation of a particular ion. For example, sodium (Na⁺), potassium (K⁺), chloride (Cl⁻), and calcium (Ca²⁺) channels have been identified. Ion channels are largely responsible for creating the cell membrane potential, which is the difference in the electrical charge on the opposite sides of the cell membrane (B. Alberts et al., supra). In animal cells, Na⁺ and K⁺ ATPases keep the intracellular concentration Na⁺ low and the intracellular concentration of K⁺ high. In opposition to these ATPases, K⁺ leak channels allow K⁺ ions to travel down the K⁺ concentration gradient and out of the cells. In this way, several ion channels collectively contribute to the formation of the cellular membrane potential.

Voltage-gated and ligand-gated ion channels are responsible for generating cell membrane action potentials in electrically excitable cells, including most muscle and nerve cells (B. Alberts, supra). For example, an action potential is triggered by cell membrane depolarization, which is caused by an influx of Na⁺ through the voltage-gated Na⁺ channels. Action potentials trigger the release of hormones and neurotransmitters in secretory cells and neurons; they trigger contractions in muscle cells and influence biochemical events and levels of gene expression. It should be noted, however, that ion channels are not limited to excitable cells. In fact, voltage-gated Na⁺, K⁺, or Ca²⁺ channels are present in various non-excitable cell types (B. Alberts, supra).

The wide variety of carrier proteins and ion channels represents a rich collection of new targets for pharmaceutical agents. Many chemicals, compounds, and ligands are known to affect carrier protein and/or ion channel activity. Moreover, agents that modulate carrier proteins and ion channels can be formulated into pharmaceutical compositions that may be used in the treatment of various diseases, injuries, or conditions (S. A. N. Goldstein et al., 1996, Neuron 16:913-919). For example, agents that modulate the activity of the ABC transporters may be used in the treatment of cystic fibrosis and/or cancer. Agents that modulate the activity of Ca²⁺ channels may be used in the treatment of epilepsy, anxiety, and Alzheimer's disease. In addition, agents that modulate the activity of Na⁺ channels may be used to treat muscle spasms, torticollis, tremor, learning disorders, brain cancer, pain, and Alzheimer's disease. Agents that block Na⁺ channels may be used as local anesthetics. Agents that modulate epithelial Na⁺ channels may be used in the treatment of cystic fibrosis, asthma, and hypertension. Furthermore, agents that modulate the activity of K⁺ channels may be used to counteract the damaging effects of anoxic and ischemic disorders and hypertension, and to protect red blood cells against damage in malaria and sickle-cell disease (J. R. Enfeild, et al., 1995, Pharmaceutical News 2:23-27).

Ion channel activity can be measured using the technique of patch-clamp analysis. The general idea of electrically isolating a patch of membrane using a micropipette and studying the channel proteins in that patch under voltage-clamp conditions was outlined by Neher, Sakmann, and Steinback in “The Extracellular Patch Clamp, A Method For Resolving Currents Through Individual Open Channels In Biological Membranes,” Pflueger Arch. 375; 219-278, 1978. They found that, by pressing a pipette containing acetylcholine (ACH) against the surface of a muscle cell membrane, they could observe discrete jumps in electrical current attributable to the opening and closing of ACH-activated ion channels. However, they were limited in their work by the fact that the resistance of the seal between the glass of the pipette and the membrane (10-50 megaohms) was very small relative to the resistance of the channel (about 10 gigaohms).

It was then discovered that by fire polishing the glass pipettes and applying gentle suction to the interior of the pipette when it made contact with the surface of the cell, seals of very high resistance (1-100 gigaohms) could be obtained. This technique reduced the background noise by an order of magnitude to levels at which most channels of biological interest could be studied. This improved seal has been termed a “giga-seal,” and the pipette has been labeled a “patch pipette.” For their work in developing the patch clamp technique, Neher and Sakmann were awarded the 1991 Nobel Prize in Physiology and Medicine.

The patch clamp technique represents a major development in biology and medicine. For example, the technique allows measurement of ion flow through single ion channel proteins, and allows the study of single ion channel responses to drugs. Briefly, in a standard patch clamp technique, a thin glass pipette (with a tip typically about 1 μm in diameter) is pressed against the surface of a cell membrane. The pipette tip seals tightly to the cell and isolates a few ion channel proteins in a tiny patch of membrane. The activity of these channels can be measured electrically (single channel recording) or, alternatively, the patch of membrane can be ruptured allowing the channel activity of the entire cell membrane to be measured (whole cell recording).

During both single channel recording and whole-cell recording, the activity of individual channel subtypes can be further resolved by imposing a “voltage clamp” across the membrane. Through the use of a feedback loop, the “voltage clamp” imposes a voltage gradient across the membrane, limiting and controlling overall channel activity and allowing resolution of discrete channel subtypes.

The time resolution and voltage control in such experiments are impressive, often in the msec or even μsec-range. However, a major obstacle of the patch clamp technique as a general method in pharmacological screening has been the limited number of compounds that could be tested per day. In addition, the standard techniques are further limited by the slow rate of sample compound change, and the spatial precision required by the patch-clamp pipettes.

A major limitation determining the throughput of the patch clamp technique is the nature of the perfusion system, which directs the dissolved test compound to cells and patches. In traditional patch clamp setups, cells are placed in large experimental chambers (0.2-2 mL wells), which are continuously perfused with a physiological salt solution. Compounds are then applied by changing the inlet to a valve connected to a small number of solution bottles. However, this technique has several drawbacks. First, the number of different compounds which may be connected at one time is limited by the number of bottles. Second, volumes of supporting liquid and/or sample required for testing remains a rate limiting step due to time and supply costs. Third, the time required to change the solute composition around cells and patches remains high. Accordingly, there have been several attempts to increase the throughput capacity of patch-clamp recordings.

The development of sophisticated systems for local application of compounds to activate neurotransmitter regulated channels, like the U-capillary and other systems, reduces the effective application times. However, the volume of bath solution exchanged by these fast application systems is quite large and results in a limited capacity for screening multiple compounds per day. This limits the use of these procedures in the medical industry due to excessive costs of reagent at the time required for testing tens of thousands of compounds or different concentrations. A major reason is the inflexibility and low capacity of the feeding systems that fill the U-capillary, which are virtually identical to the systems used in conventional patch clamp experiments.

U.S. Pat. Nos. 6,063,260, 6,117,291, and 6,470,226 to Olesen et. al. (collectively, “Olesen”) disclose a computerized motor control system that causes a patch pipette to patch a cell automatically selected from a cell bath. The pipette tip and cell then remain affixed in a perfusion chamber for patch clamp measurements. An autosampler controls a valve that alternately directs fluid from various sources into the perfusion chamber, including one or more test chemical solutions and washing solutions. A duct in the perfusion chamber aspirates used fluid out of the chamber. Patch clamp measurements may be taken when the cell is bathed in a test solution. In Olesen, the perfusion chamber does not move. Rather, a complicated set of tubes and pumps is used to pump test chemicals and washing baths into and out of the interface chamber. Thus, instead of moving the cell (and pipette) to different test and wash solutions, the solutions are brought to the stationary cell via an autosampler. To minimize test solution, Olesen positions the autosampler very close to the perfusion chamber. Special care must be taken to minimize the electrical interference (and vibrations) caused by the autosampler when taking patch clamp measurements.

U.S. Pat. No. 6,048,722 to Farb et. al. (“Farb”) discloses an automatic patch clamp perfusion system that perfuses patched cells with a plurality of test and wash solutions. The test and wash solutions drain from a plurality of reservoirs through a multi-barrel manifold into the recording chamber, which contains the patched cell. A valve controls which solution perfuses the cell at a given time. As in the Olesen system, the Farb system causes the solutions to move to the cell rather than moving the cell to the solutions.

U.S. application Ser. No. 09/900,627 filed Jul. 6, 2001 by Weaver et. al. (“Weaver”) discloses a system that can measure electrical properties of cells that does not use a pipette tip to attach to cell membranes. Rather, a plurality of pores on a porous surface attach and seal to a plurality of cell membranes. One side of the porous surface is coupled to a ground electrode, and the other side is coupled to a measuring electrode. In one embodiment where the porous surface is a microchip, each cell may be attached to its own ground and measuring electrodes, allowing for cell-specific measurements. When test solutions are applied to one or more sides of the porous surface, a patch clamp recording can be measured for the attached cells. The system can be automated so that multiple porous surfaces are tested simultaneously on a multi-well plate.

U.S. patent application Ser. No. 10/239,046 (Pub. No. U.S. 2003/0139336 A1) filed Mar. 21, 2001 by Norwood et. al. (“Norwood”) provides a system wherein a patch pipette is attached to a cell located at the liquid-air interface of a suspended liquid, such as a drop of liquid suspended from the bottom of a capillary tube. Increasing (or decreasing) pressure inside the tube causes the meniscus, the liquid-air interface, to bulge outward (or inward). Because the cell is located at the meniscus, the position of the cell can be controlled by regulating the internal tube pressure. Bulging the meniscus outward causes the cell to contact a patch pipette located just beneath the tube and facing upward towards the meniscus. Once the cell touches the patch pipette, the pipette may form a giga-seal (giga-ohm seal) and “patch” the cell in preparation for patch clamp measurements. In the Norwood system, the cell is outside the patch pipette before it is patched. Also, the air pressure system is applied to a second tube that holds and suspends the cellular liquid; air pressure is not applied to the patch pipette itself.

There remains a need for a faster, cheaper, and/or more practical method of conducting high throughput screening. Such high-throughput screens would be invaluable for the search and identification of agents that modulate ion channel activity. In turn, such agents would be useful for the treatment of various diseases, such as cancer, heart disease, cystic fibrosis, epilepsy, pain, blindness, and deafness.

### SUMMARY OF THE INVENTION

The invention provides a system for automatic drug handling and application, and utilizes the system for screening of chemicals such as drugs. In particular, the methods and system may be used to measure the effect on ion channel transfer, while providing high throughput and low fluid volume requirements. For purposes of the invention “ion channel” refers to leak channels, voltage-gated channels, mechanically-gated channels, ligand-gated channels, and any other class of channel protein.

One embodiment of the invention reduces the amount of chemical compound required for testing. Another embodiment provides a method whereby a large number of screenings can be applied to a single cell resulting in an increased rate of screening.

Another embodiment provides a system and methods of using the system to keep a cell immersed in liquid during the entire screening process. Another embodiment minimizes the equilibrium time for the perfusate surrounding the cellular membrane under patch clamp control, necessary for studying fast-desensitizing ligand-gated ion channels.

One embodiment of the invention provides a system comprising an interface chamber, wherein said interface chamber provides an interface bath capable of suspending a cell. The system is particularly applicable to methods for carrying out patch clamp techniques.

Another embodiment provides an interface system comprising an interface chamber, wherein a cell is affixed to a capillary through a gigaseal, and wherein said interface chamber and capillary are relatively movable so that the capillary can slide through the interface chamber, said interface chamber being suitable for suspending a liquid.

Another embodiment provides a patch clamp system comprising a capillary comprising an electrode; a cell coupled to said capillary in a manner sufficient to form a giga-seal between the capillary and the cell membrane of said cell; an interface chamber comprising an electrode, wherein said interface chamber and capillary are relatively movable so that the capillary can slide through the interface chamber, said interface chamber being suitably shaped to contain and suspend a liquid; a device for measuring at least one of current and voltage between said electrodes; and a plate comprising a plurality of reservoirs, wherein at least one reservoir comprises a test compound.

In one embodiment, the invention provides a method of measuring the properties of a cell comprising placing a cell in an interface chamber wherein said interface chamber suspends said cell in an interface bath in the interface chamber, and wherein said cell is affixed to a capillary. One or more properties of the cell may then be measured.

In another embodiment, the invention provides a method of measuring properties of a cell comprising placing a cell in an interface chamber, wherein said cell is affixed to a capillary through a gigaseal, and wherein said interface chamber and capillary are relatively movable so that the capillary can slide through the interface chamber. One or more properties of the cell may then be measured.

Yet another embodiment provides a method of measuring the properties of a cell, comprising establishing an interface system, comprising an interface chamber, wherein a cell is affixed to a capillary in a manner sufficient to form a seal between the capillary and the cell, and wherein said interface chamber and capillary are relatively movable so that the capillary can slide through the interface chamber, said interface chamber being suitably shaped to contain and suspend a liquid; establishing a means for measuring at least one of current and voltage between said electrodes; transferring the interface system to a reservoir comprising a test compound; and measuring the electrical current flowing across the cell membrane.

Another embodiment provides a method of attaching a cell to a capillary. Positive pressure is applied inside the capillary. The capillary is inserted into a layer of cells. The pressure inside the capillary is decreased to form a gigaseal between a specific cell and the capillary. After the decreasing step, the capillary is removed from the layer of cells. After the removing step, the pressure inside the capillary is further decreased to establish a whole cell configuration for the specific cell.

The foregoing and other objects, advantages, and characterizing features of the invention will become apparent from the following description of certain illustrative embodiments thereof considered together with the accompanying drawings, wherein like reference numerals signify like elements throughout the various figures.

### DESCRIPTION OF THE DRAWINGS

FIG. 1A-1C illustrate an exemplary patch clamp system wherein a coil-shaped interface chamber is positioned relative to a cell to form an interface system.

FIG. 2A-2C show a high cell density blind patch clamp according to an embodiment of the invention.

FIG. 3 illustrates an exemplary patch clamp system comprising an interface system and multi-well plate.

FIG. 4 shows an exemplary embodiment of the capillary and cell.

FIG. 5 illustrates an exemplary interface system.

FIG. 6 is a flow chart showing a method of using the system of FIG. 1A-1C.

FIG. 7 illustrates a graph showing current across a cell membrane versus time.

FIG. 8 illustrates a graph showing the peak current and a fractional block versus the concentration of a test substance.

FIG. 9 illustrates a graph showing current across a cell membrane versus time.

FIGS. 10A-10B illustrate a graph showing ion channel current measurements obtained using an embodiment of the invention.

FIGS. 11A-11B illustrate a graph showing ion currents obtained from HEK293 cells stably expressing hERG channels.

FIGS. 12A-12B illustrate a graph showing the effect of E4031 on potassium current in HEK293 cells stably expressing hERG channels.

### DETAILED DESCRIPTION OF THE INVENTION

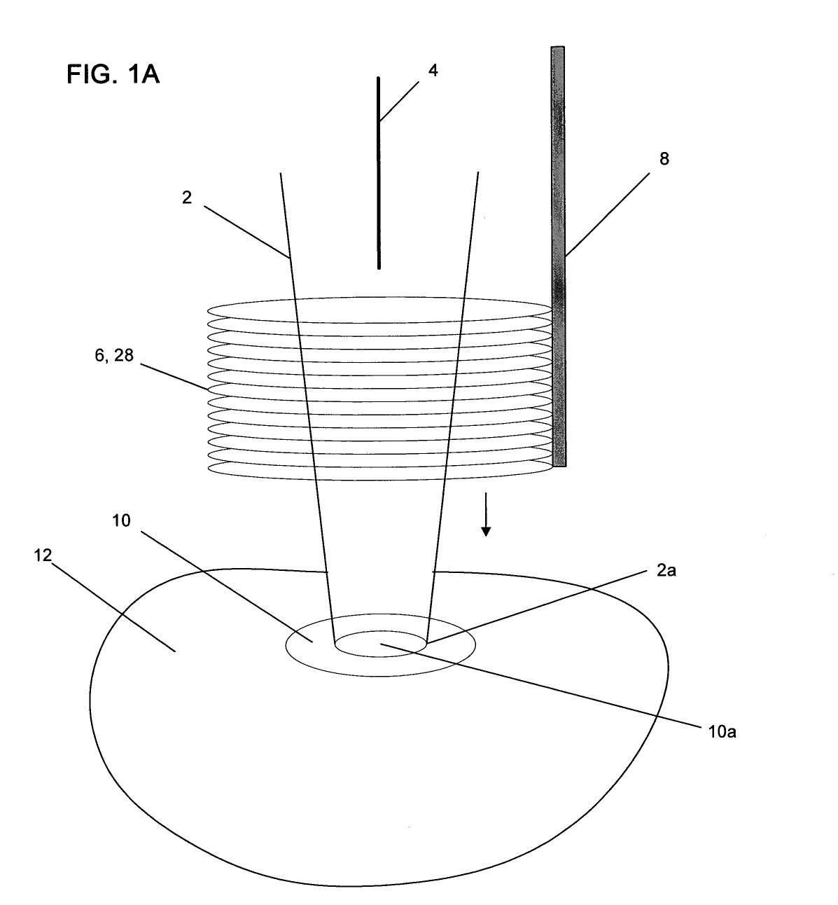

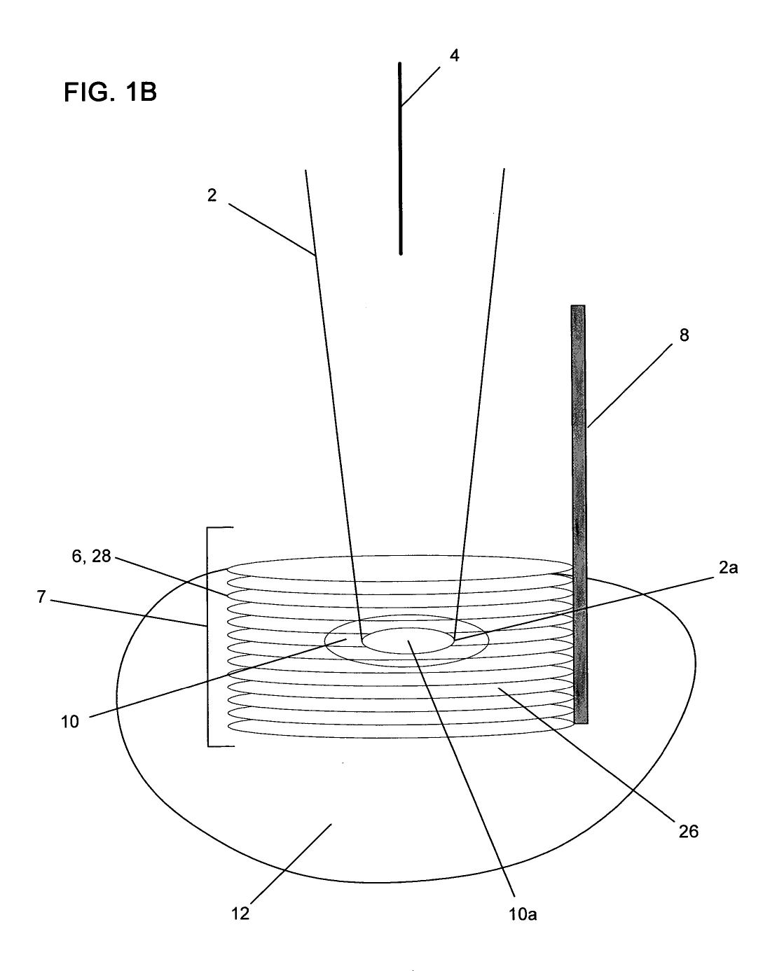

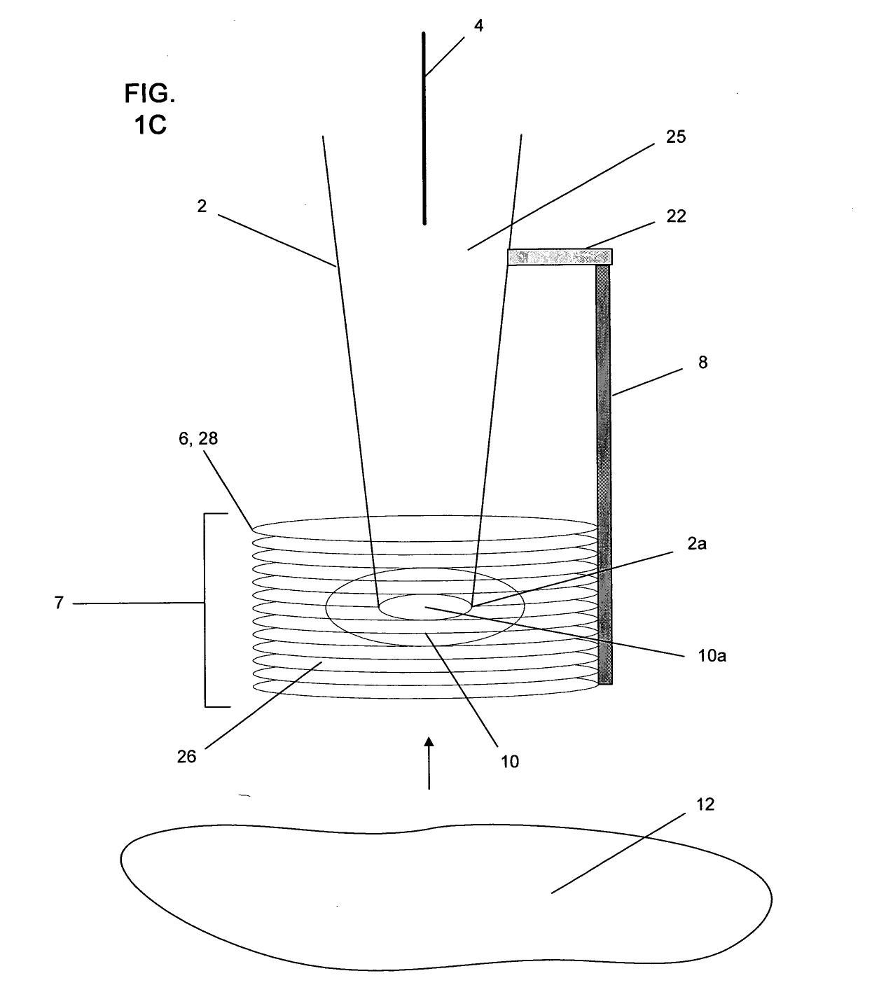

FIGS. 1A-1C illustrate an interface system 7 according to one embodiment of the invention. The interface system 7 may comprise a cell 10, a capillary 2 which may couple to the cell membrane 10a, an interface chamber 6 movable to enclose the capillary tip 2a, a rod 8 coupled to the interface chamber 6, and a liquid 12 which may submerge the capillary tip 2a.

As shown in FIG. 1A, a whole-cell configuration of the patch clamp technique may be established, for instance under a microscope. In FIG. 1B, the coil-shaped interface chamber 6 may be pulled over the electrode tip and the cell may be bathed in solution, forming an interface system 7. In FIG. 1C, the interface system 7 may be removed from the solution.

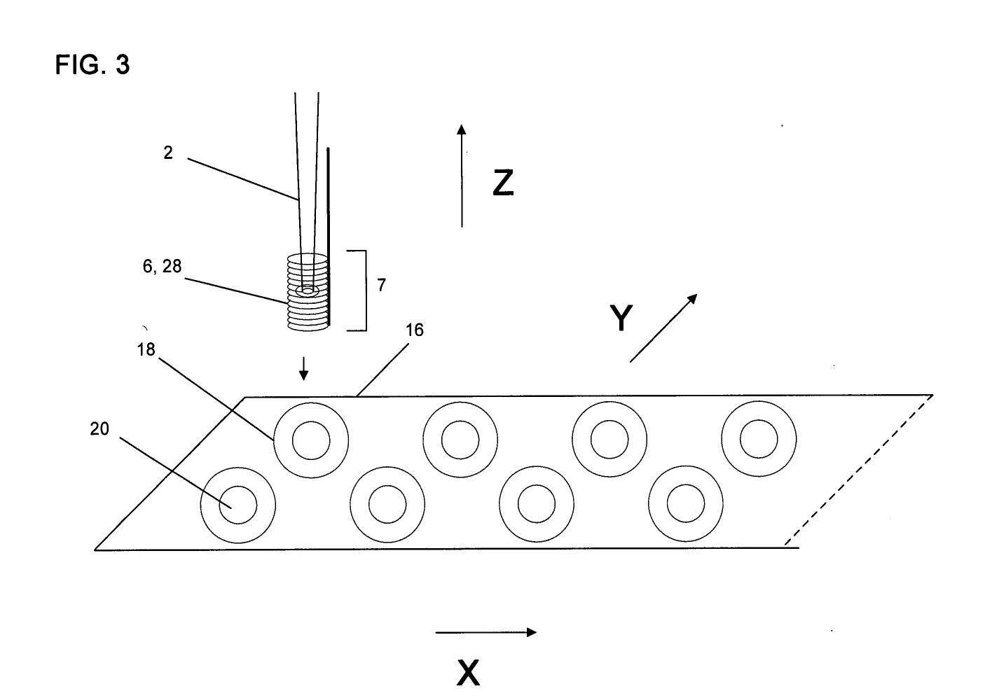

As shown in FIGS. 1B, 1C, and 3, an “interface system” 7 may comprise a capillary 2, a cell 10 affixed to the capillary tip 2a in a manner sufficient to form a seal between the capillary 2 and the cell membrane 10a, and an interface chamber 6 which encloses the capillary tip 2a, the cell 10, and a small volume of liquid 26 suspended in the interface chamber 6 by capillary forces and/or the surface tension of the liquid. The liquid 26 may be suspended in an interior region of the interface chamber 6.

The capillary 2 may be hollow at one or both ends, and it is preferably approximately cylindrical in shape. The capillary 2 may comprise an opening at its tip 2a. The capillary 2 may be approximately conical in shape. The capillary tip 2a may be of a size and shape such that it can be attached to a cell 10, such as a mammalian, insect, amphibian, or other cell. For instance, the opening of the capillary tip 2a may have a diameter of approximately 0.1 to 10 microns.

The capillary 2 may comprise any tubular device or any portion of a device that is tubular in shape. Preferably the capillary 2 comprises a patch pipette. As used herein, the term “patch pipette” refers to any tube used in patch clamping techniques that attaches to a cell 10 and forms a gigaseal. More preferably, the capillary 2 comprises a tube ending in a conical shape with a capillary tip 2a and is termed a “micropipette.” The opening of the micropipette tip 2a may be configured to be attached to the cell membrane 10a of an animal cell 10, such as a mammalian cell.

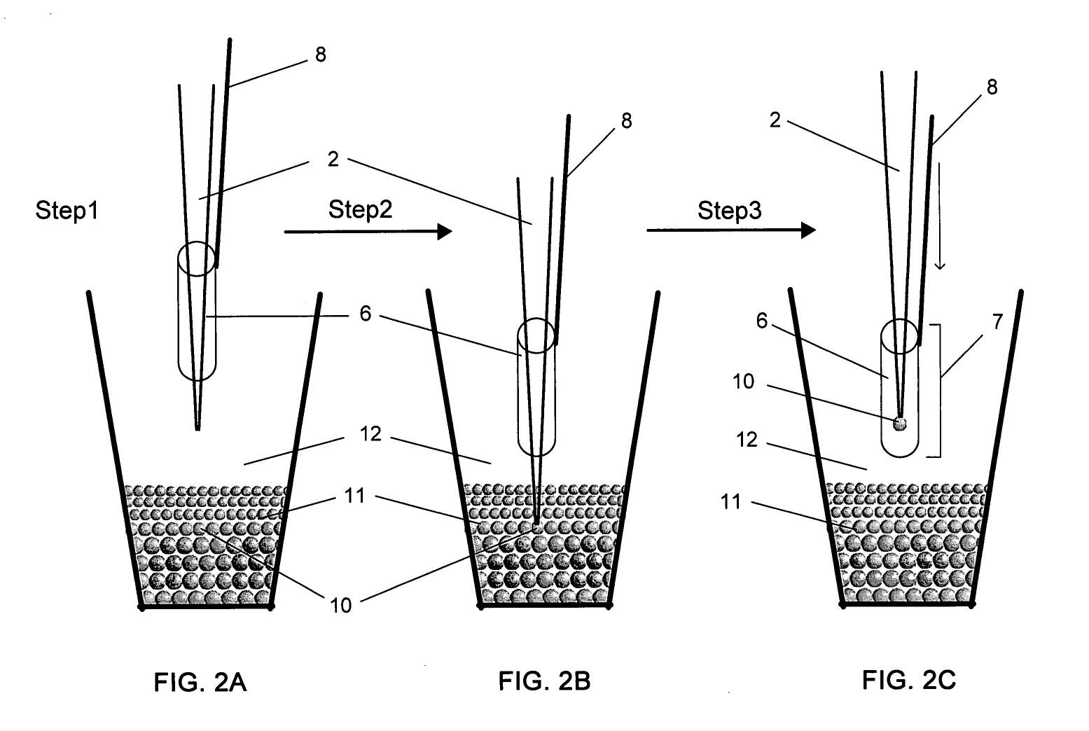

FIGS. 2A-2C show a high cell density blind patch clamp according to an embodiment of the invention. This high cell density blind patch clamp may be used to attach a cell 10 to a capillary 2. In one embodiment, cells stably expressing hERG channels may be enzymatically isolated by conventional methods, collected in a tube, and centrifuged. The cells may be subsequently collected into another tube and allowed to settle into a dense cell layer 11, e.g., a layer of 1-10 mm in depth, preferably 2-7 mm in depth, more preferably 3-5 mm in depth. The nature of the above mentioned cell layer 11 enables insertion of a patch pipette 2 into the cells without breaking the pipette tip 2a. For example, the patch pipette tip 2a may be inserted 1-4 mm deep into the cell layer 11. This may enable blind manipulation of the patch pipette and a blind formation of a high-resistance tight electrical junction (gigaseal) between the cellular membrane of a particular cell 10 and the patch pipette 2. One method of achieving this is described as follows.

First, referring to FIG. 2A, positive pressure may be applied inside the patch pipette 2. The positive pressure may be, e.g., of 900-1000 mm Hg (absolute). The pipette 2 may be positioned inside the tube above the cell layer 11 surface, e.g., 10 mm above the surface.

Second, referring to FIG. 2B, the patch pipette 2 may be inserted into the cell layer 11. Depth of the insertion may vary between any range of millimeters or micrometers. In the example shown in FIG. 2B, the depth may vary, e.g., between 1 and 5 mm. Changing pressure (e.g., to 700 mm Hg) may cause spontaneous formation of a gigaseal between the pipette 2 and a specific cell 10. Following gigaseal formation, the patch pipette 2 and the cell 10 attached to the pipette tip 2a may be removed from the cell layer 11. The pipette 2 and cell 10 may then be positioned above the cell layer 11, e.g., 10-15 mm above the layer 11.

Third, referring to FIG. 2C, a whole-cell configuration may be established by changing the pressure inside the patch pipette 2, e.g., to 600-650 mm Hg. Thereafter, pressure may be kept at another pressure, e.g., a higher pressure such as 700-740 mm Hg, in order to ensure stability of patch-clamp recordings.

It should be noted that an interface chamber 6 may be used to contain the cell 10 and/or liquid 12 at any point during the process shown in FIGS. 2A-2C. For instance, while the pipette 2 is in the position shown in FIG. 2B, the interface chamber 6 may be moved from a position on the axis of the pipette 2 above the surface of the liquid 12 to a position below the surface of the liquid 12 wherein the interface chamber 6 contains the cell 10, as is shown in FIG. 2C. This may occur after (or before) the pipette 2 forms a gigaseal with the cell 10. In a preferred embodiment, the interface chamber 6 is not inserted into the cell layer 11, as that could potentially damage the cells and sequentially increase failure rate (FIG. 2B).

Once the cell 10 is attached to the patch pipette 2, it is moved out of the cell layer 11 (FIG. 2C) and the interface chamber 6 is positioned in a way to cover the patched cell 10. The interface chamber 6 and pipette 2 may then be moved as a composite entity, i.e., as the interface system 7, preserving the relative position of the cell 10, pipette 2, and interface chamber 6. If desirable, the interface system 7 may now be moved from the tube and into one or more different reservoirs 18, via air, safely. This or a related method may be preferred when it is desirable to avoid exposing the cell 10 to air, as the interface chamber 6 is capable of suspending a liquid bath surrounding the cell 10.

Other embodiments of the invention are directed to methods of using the interface system 7 of the invention, e.g., FIGS. 1B, 1C, and 3, to measure the properties of a cell 10. The interface system 7 comprises a capillary 2, a cell 10 affixed to the capillary tip 2a in a manner sufficient to form a seal between the capillary 2 and the cell membrane 10a of the cell 10, and an interface chamber 6 which encloses the capillary tip 2a, the cell 10, and a small volume of liquid 26 suspended in the interface chamber 6 by capillary forces and/or the surface tension of the liquid.

FIG. 3 illustrates an exemplary patch clamp system comprising an interface system and multi-well plate. The patch clamp system may comprise a multi-well plate 16 comprising one or more reservoirs 18. As used herein, the term “reservoir” refers to any surface capable of containing a small volume of liquid. This includes wells and depressions, as well as flat surfaces wherein a small volume of liquid forms a distinct droplet of liquid, held together by the surface tension of the liquid. Preferably, the reservoir 18 can hold a minimum liquid volume of 1 uL, 5 uL, 10 uL, 50 uL, 100 uL, 200 uL, or 500 uL. The reservoir 18 can preferably hold a maximum liquid volume of 1 mL, 2 mL, 5 mL, or 10 mL. The reservoir may also hold any combination of these minimum and maximum values; for instance, the reservoir 18 may hold incremental amounts of liquid, such as between 5 uL and 2 mL, or between 100 uL and 1 mL, as well as increments between the increments. More preferably, the reservoir 18 can hold between 10 uL and 2 mL of liquid. Even more preferably, the reservoir 18 can hold between 20 uL and 1 mL of liquid. The reservoirs 18 may each comprise one or more test compounds 20, or may comprise a neutral solution. The test compound 20 may comprise a drug, or alternately, it may comprise an inert liquid, such as an inert aqueous or saline solution.

Preferably the interface chamber 6 comprises an electrode, and preferably the capillary tip 2a is sealed to the cell membrane 10a. In one embodiment, the interface system 7 may be transferred to a reservoir 18 comprising a solution comprising a test compound 20. The electrode 4 is preferably attached to a device that measures current through the electrode 4 and/or a device that measures voltage across the electrode 4 and another reference, such as the interface chamber 6. An external electrical current may be imposed on said electrodes to establish a reference voltage or current at a desired value. Furthermore, the electrical current flowing across the cellular membrane 10a (and/or voltage across the interface chamber 6 and electrode 4) may be measured in an electrical measuring means comprising a circuit connected between the interface chamber 6 and the electrode 4 before and/or after introduction of the interface system 7 to a solution comprising a test compound 20.

In preferred embodiments one or more of the following parameters (e.g., electrical properties) may be measured in the cell: current in voltage-clamp, voltage across the electrodes and/or across the cell or cell membrane, electric resistance, impedance, electric capacitance, optic fluorescence, plasmon resonance, mechanic resonance, fluidity and/or rigidity.

In another aspect of this invention, further tests may be conducted on the same cell 10. In this aspect of the invention, the interface system 7 may be removed from the reservoir 18 and washed by introduction of the interface system 7 to a solution 20 without test compound. Preferably washing is performed 2 to 5 times, such that any test compounds that remain in the fluid contained in the interface chamber 6 are diluted below their level of activity on the cell 10. The interface system 7 may then be transferred to another reservoir 18 comprising a solution comprising another test compound 20 (or a washing solution). Alternatively, if the cell 10 is to be moved from lower concentrations to higher concentrations of the same test compound, the washing step may be eliminated according to standard laboratory practice. Electrical properties of the cell, cell membrane, or system may be measured, as discussed above. This process is repeated as many times as desired.

The reservoirs 18 are preferably provided by a multi-well or microtiter plate 16. For purposes of the invention, reservoir 18 shall mean wells and depression for holding liquids, as well as flat plate arrays that provide sufficient surface tension to allow coalescence of a test sample sufficient for insertion of the interface chamber into the reservoir 18. The reservoirs 18 may comprise one or more different compounds. In one aspect of this invention, the test compound 20 comprises a drug candidate or active agent, such as a channel or transporter blocking or activating agent. For example, the reservoirs 18 may contain a solution of a drug that treats cancer. The test compound 20 may also comprise an inert liquid, such as an inert aqueous or saline solution.

Preferably, the solution of test compound 20 required to measure the properties of a cell 10 is less than 5 milliliters in volume. The minimum volumes required may be 10 uL, 20 uL, 30 uL, 50 uL, and 80 uL, and increments between these volumes. The maximum volumes required may be 0.5 mL, 1 mL, 2 mL, and 5 mL, and increments between these volumes. The test solution volume may also be any combination of these minimum and maximum values; for instance, the volume may be incremental amounts of liquid, for example, between 30 uL and 0.5 mL, or between 50 uL and 5 mL. More preferably, the volume is between 20 uL and 1 mL. For instance, there may be a 96-well plate wherein each well is designed to hold up to 0.3-0.35 mL of solution.

An advantage of the invention is that it enables fast transfer of the target cell 10 from one reservoir 18 to another. The interface system 7 can simply be removed from one reservoir 18 and inserted in another. There is no need for the time-consuming operations of compound dilution and perfusion system adjustment. Importantly, the often slow step of replacing the contents of a bath chamber containing a cell 10 by perfusion is reduced to the time that it takes to move the interface system 7 from one reservoir 18 to the next. Moreover, the invention dispenses with the need for additional tubing or accessories, which significantly cuts down on cost and accidental contamination with residues that might reside inside a perfusion system. Test compounds 20 can often adhere to tubing used for perfusion systems, requiring cleaning or replacing of the tubing. This problem is eliminated by the testing system of the present invention.

Another advantage of the invention is that it provides a small interface bath 26 volume surrounding the cell 10 while the cell 10 is in the interface system 7, which ensures a small dilution volume while moving the cell 10 from one reservoir 18 to another. For instance, in a preferred embodiment, the volume of the interface bath 26 is between 1/50^{th} and 3/10^{ths} the volume of the solution in a reservoir 18, as well as any increments between these volumes. More preferably the volume of the interface bath 26 is less than 2/10^{ths} the volume of the solution in a reservoir 18.

Preferably, the interface bath 26 can hold incremental amounts of a liquid, for example, a minimum volume of 0.02 uL, 0.1 uL, 0.2 uL, 1 uL, 2 uL, 5 uL, 10 uL, or 20 uL, as well as any increments between these volumes. The interface bath 26 can preferably hold a maximum liquid volume of 0.03 mL, 0.05 mL, 0.1 L, 0.5 mL, 1 mL, 2 mL, or 5 mL, as well as any increments between these volumes. The interface bath 26 may also hold any combination of these minimum and maximum values; for instance, the interface bath 26 may hold between 2 uL and 0.5 mL, or between 10 uL and 0.05 mL. More preferably, the interface bath 26 can hold between 10 uL and 0.5 mL of liquid. Even more preferably, the interface bath 26 can hold between 0.02 mL and 0.03 mL of liquid. For instance, the interface bath 26 may have a volume of 0.02-0.03 mL and the volume of reservoir solution may be 0.3-0.35 mL. A small interface bath 26 volume further provides an improved equilibration time as dilution of the interface bath 26 will occur quickly by compound 20, and allows test compounds 20 to be conserved since smaller bath volumes can be used.

Another advantage is that due to the fast application time of test and wash solutions, some embodiments of the invention are amenable to measuring ligand gated channels. This advantage would be most apparent with desensitizing ligand gated channels, as ionic currents would be detected prior to their desensitization (i.e. before they decrease below baseline levels). In this application, a recording from a cell expressing an appropriate ligand gated channel would be obtained as described above. Soluble ligand would be placed into wells of the plate, and upon movement of the cell into the well, current would be induced. Wells could also contain a test compound (in addition to the ligand), and thus compound effects on ligand gated channels could be examined.

In another aspect of this invention, any method of using the interface system 7 of FIGS. 1 and 3 to measure the properties of a cell 10 may optionally be automated by standard robots and mechanical devices controlled by computers. For instance, a mechanical system may couple to the capillary 2 and rod 8 and move the interface system 7 from one reservoir 18 to another. Also, a plurality of capillaries 2, each with a cell sealed to the capillary tip 2a, may be coupled to one another. The plurality of capillaries 2 and rods 8 can be inserted into a plurality of reservoirs 18. This would allow tests of multiple cells 10 at the same time.

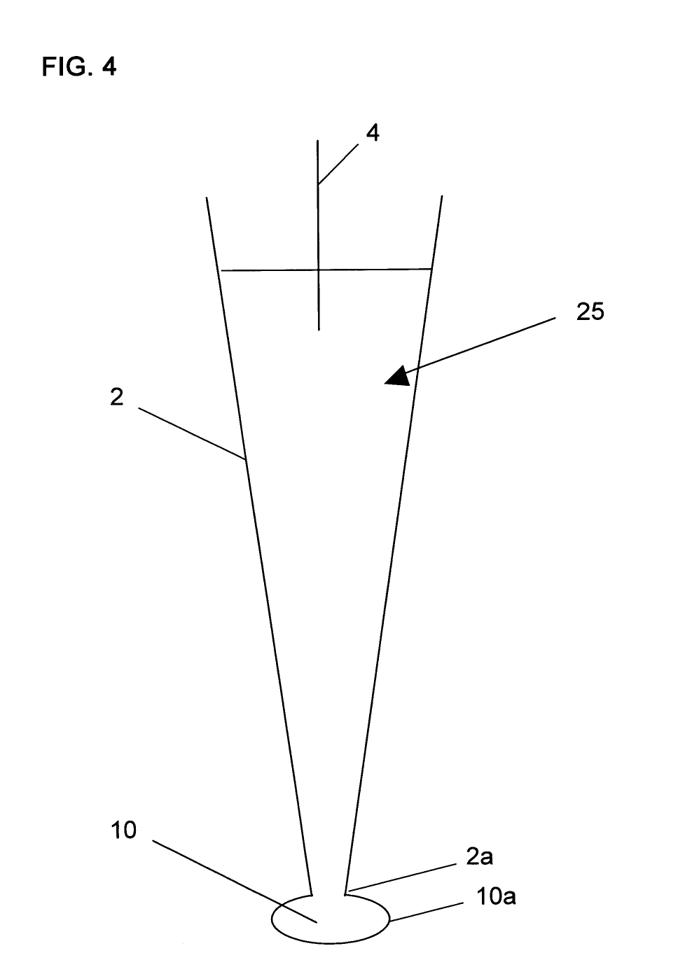

FIG. 4 shows an exemplary embodiment of the capillary 2 and cell 10 according to an embodiment of the invention.

The length of the capillary 2 is not critical for the invention provided it allows for formation of a capillary tip 2a which can obtain a proper seal on a cell 10, preferably a gigaohm-seal. Preferably, the capillary 2 can be made from different non-conductive materials such as plastics (e.g. polystyrene) or glass. More preferably, the capillary 2 is made from any material that binds tightly to biological membranes, has good dielectrical properties, is inert to a wide range of chemicals, and can be easily cleaned. For instance, the capillary 2 may comprise glass.

An electrode 4 may be inside the capillary tip 2a, and it may be attached to an electronic amplifier. The electrode 4 may be configured to measure current across the cell membrane 10a. As used herein, the term “electrode” refers to a physical transmitter or conductor which may conduct or otherwise pass electric signals from the capillary solution 25 (or cell 10) to an amplifier. The capillary solution 25 may conduct electricity between the cell 10 and the electrode 4. Here, the electrode 4 may be inside (or partially inside) the capillary 2. When the electrode 4 is touching the capillary solution 25 inside the capillary 2, the capillary 2 acts as a patch electrode. As used herein, the term “patch electrode” refers to a patch pipette 2 further comprising an electrode 4, all of which attaches to the cell 10. Accordingly, the terms “patch electrode” and “capillary electrode” are interchangeable for purposes of this invention.

For purposes of this application, the electrode 4 refers to the structure that is used to measure (or affect) electrical properties of the cell from within the capillary 2 (i.e., the “patch electrode”). This structure may comprise the electrode 4 as well as the solution 25. This structure 4 is different from the reference electrode 28 which is used to measure (or affect) electrical properties outside the capillary 2. The gigaohm seal at the capillary tip 2a creates an electrical barrier between the realm of influence of the two electrodes 4, 28.

In a preferred embodiment the patch electrode 2 is a microelectrode. As used herein, the term “microelectrode” refers to a patch electrode 2 of appropriate size for recording signals from individual cells.

According to an embodiment of the invention, the tip of the patch electrode 2 may be brought into contact with the cell 10 to form a patch clamp recording. As used herein, the term “patch clamp” refers to a patch electrode configuration that allows the recording of signals from a biological membrane by placing a patch electrode in contact with a small area of the cell membrane. The patch clamp may be a “whole-cell patch clamp,” which refers to a patch electrode configuration that allows the recording of signals from the entire membrane of a cell by placing a patch electrode in contact with a small area of the cell membrane and then rupturing that small area of cell membrane (the patch).

When the capillary tip 2a contacts the cell membrane of the cell 10a, a seal may be formed between the capillary tip 2a and the cell 10. Preferably, the seal is sufficiently tight, and a resistance exceeding 1 gigaohm, preferably 10 gigaohms, is obtained between the cell membrane 10a and the capillary tip 2a. Methods of making gigaohm-seals are well known in the art.

The electrode 4 may be attached to a measuring device that measures current and/or voltage across the electrode 4 and another reference, such as the interface chamber 6 or reference electrode 28. The electrode 4 may be configured to measure the voltage and/or current across the membrane 10a of a cell 10 in contact with the capillary tip 2a, said cell 10 and capillary tip 2a being enclosed within an interface chamber 6 comprising an electrode.

Returning to FIGS. 1A-1C and 3, the interface chamber 6 of the invention may be shaped in such a way as to comprise a hollow cavity. The cavity is preferably a size and shape such that the surface tension and/or capillary forces are sufficient so that the liquid 26 adheres within the interface chamber 6. Preferably, the interface chamber 6 can suspend as little as 1 uL and as much as 1 mL. Thus, the interface chamber 6 can suspend incremental amounts of liquid, for example, 1 uL, 5 uL, 10 uL, 20 uL, 50 uL, 100 uL, 200 uL, 500 uL, 750 uL, or 1 mL of liquid, as well as increments between the increments. As used herein, the term “suspend” refers to the ability to contain or hold a liquid.

In some embodiments, the cavity of the interface chamber 6 is wider than the width of the capillary tip 2a so that the capillary tip 2a can be fully enclosed within the interface chamber 6. Preferably the interface chamber 6 is substantially cylindrical in shape, as exemplified in FIG. 1A. The interface chamber 6 may be comprised of any solid material. Preferably, the interface chamber 6 is comprised of a conductive material, such as metal. In some embodiments the interface chamber 6 has the capacity to act as a reference electrode 28.

In a preferred embodiment, the interface chamber 6 may comprise an electrode 28, such as a metal coil as exemplified in FIGS. 1 and 3. Accordingly, the interface chamber 6 may have two functions, as an interface chamber 6 to contain liquid 26 and as a reference electrode 28 for patch clamp measurements. Preferably the coil 6, 28 has a diameter of between 1 millimeter to 10 millimeters. Preferably the distance between the rings of the coil is between 0.01 millimeters to 2 millimeters.

One advantage of the coil-shaped interface chamber/electrode 6, 28 is that it provides a maximal liquid surface area, thereby enabling a maximal effect of capillary forces and/or surface tension to hold liquid 26 inside the interface chamber 6. This in turn provides for a steady reference voltage measurement of the liquid 26 (maintained in part by the reference electrode 28), which helps in obtaining accurate patch clamp measurements.

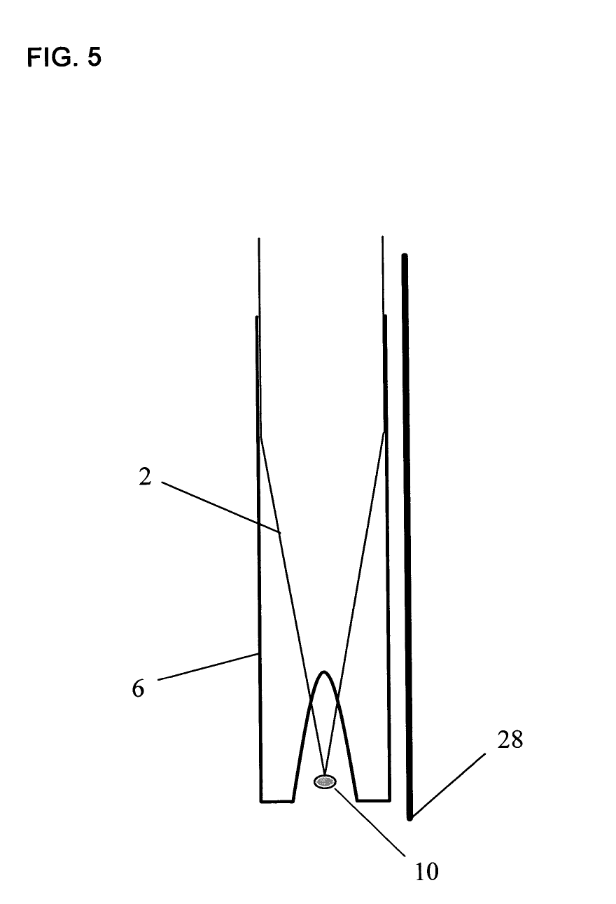

FIG. 5 shows another embodiment of the interface chamber 6. In this embodiment, the interface chamber 6 comprises a tube. The tube 6 may be made of plastic or another material (such as another non-conducting material). A reference electrode 28 may be outside the tube 6. The reference electrode 28 can be coupled to the tube 6. The tube 6 may have a radius nearly equal (but slightly greater than) the radius of the capillary 2, such that the capillary 2 can be coupled to the tube 6 by sliding the capillary 2 into the tube 6 (or the tube 6 into the capillary 2). Friction between the tube 6 and the capillary 2 may cause them to be coupled together upon insertion, in a manner similar to how a pen may coupled to a pen cap.

In a preferred embodiment, a rod 8 may be coupled to the interface chamber 6, as shown in FIGS. 1 & 2. In an alternative embodiment, the rod 8 and the interface chamber 6 together comprise a rigid component device. The rod 8 may comprise any rigid material. Preferably, the rod 8 is suitable for coupling to a machine, so that the machine can control the movement of the interface chamber 6 by moving the rod 8. Preferably, the surface of the rod 8 comprises a non-conducting material, such as a plastic or ceramic so that when humans or machines touch the surface of the rod 8, they do not affect the electrical properties of the interface chamber 6.

In some embodiments, the rod 8 has an inner core that comprises the reference electrode 28 or a conductor connected to the reference electrode 28. (Thus, either the interface chamber 6, the rod 8, or both the interface chamber 6 and rod 8 may comprise the reference electrode 28.) The rod 8 may be coupled to the interface chamber 6 on one end and to an electrical measuring device on another end.

The electrical measuring device may also be coupled to the electrode 4, so that the electrical measuring device, electrode 4, and reference electrode 28 are part of a closed circuit. The closed circuit may also include the cell 10 and the liquid 26 inside the interface chamber 6. The inner core of the rod 8 may thus enable the electrical measuring device to control and/or monitor the electrical properties of the interface chamber 6, such as the current passing through the cell membrane 10a or the voltage across the reference electrode 28 and another device, such as the electrode 4.

The rod 8 may be used to move the interface chamber 6. In a preferred embodiment, the rod 8 is used to move the interface chamber 6 along the axis of the capillary 2. In this way, the relative movements of the capillary 2 and interface chamber 6 can cause the capillary tip 2a to move inside the interface chamber 6. In one embodiment, the rod 8 may be used to move the interface chamber 6 in a back-and-forth motion along the length of the rod 8. For instance, a person or machine could move the rod 8 and accordingly move the interface chamber 6 coupled to the rod.

The rod 8 may be coupled to the capillary 2 by a fastener 22 (shown in FIG. 1C) so that both can be easily moved together with little or no relative movement. The fastener 22 may be attached to the capillary 2, and/or it may be attached to the rod 8. The fastener 22 may comprise any coupling means for coupling the capillary 2 to the rod 8. In this way, the capillary tip 2a may stay in a fixed position relative to the interface chamber 6. In a preferred embodiment, the rod 8, interface chamber 6, and fastener 22 comprise a rigid apparatus that can be moved with little or no relative movement of its component parts. Also, in a preferred embodiment, the fixed position of the capillary tip 2a may be near or at the center of the interface system 7.

Alternately, the fastener 22 may couple the capillary 2 directly to the interface chamber 6. In this event, the fastener 22 preferably comprises a non-conductive material to avoid affecting the electrical properties of the interface chamber 6.

If liquid 26 is suspended inside the interface chamber 6, the capillary tip 2a may move inside the liquid 26. Alternatively, if the capillary tip 2a is already in a liquid bath 12, the interface chamber 6 may be moved into the bath 12 so that the interface chamber 6 encloses the capillary tip 2a and/or all or a portion of the liquid bath 12. When the interface chamber 6 is removed from the liquid bath 12, all or a portion of the liquid from the liquid bath 12 is contained in the cavity of the interface chamber 6 as a result of the liquid's surface tension and/or capillary forces. This volume of liquid 26 contained in the cavity of the interface chamber 6 is referred to hereinafter as the “interface bath” 26.

A variety of different cell types can be examined with the present system. A non-exhaustive list of some of the cells that can be examined include: Jurkat lymphoma cells; HEK293 cells; Chinese hamster ovary (CHO) cells (e.g., ion channel/transport protein containing cell lines); primary cells from neuronal tissue such as hippocampus, ganglion, and neuroendocrine cells; skeletal muscle; smooth muscle; heart muscle; immune cells; blood cells; epithelia; endothelia; plant cells; and genetically engineered cells. In a preferred embodiment of the invention, an animal cell 10 is sealed to the capillary 2 and tested. More preferably, the cell contains an ion channel or transport protein in its cell membrane 10a, either naturally or introduced artificially by well-known molecular biological techniques. In one embodiment, the cell 10 is a mammalian, insect, or amphibian cell. More preferably, the cell is a human cell.

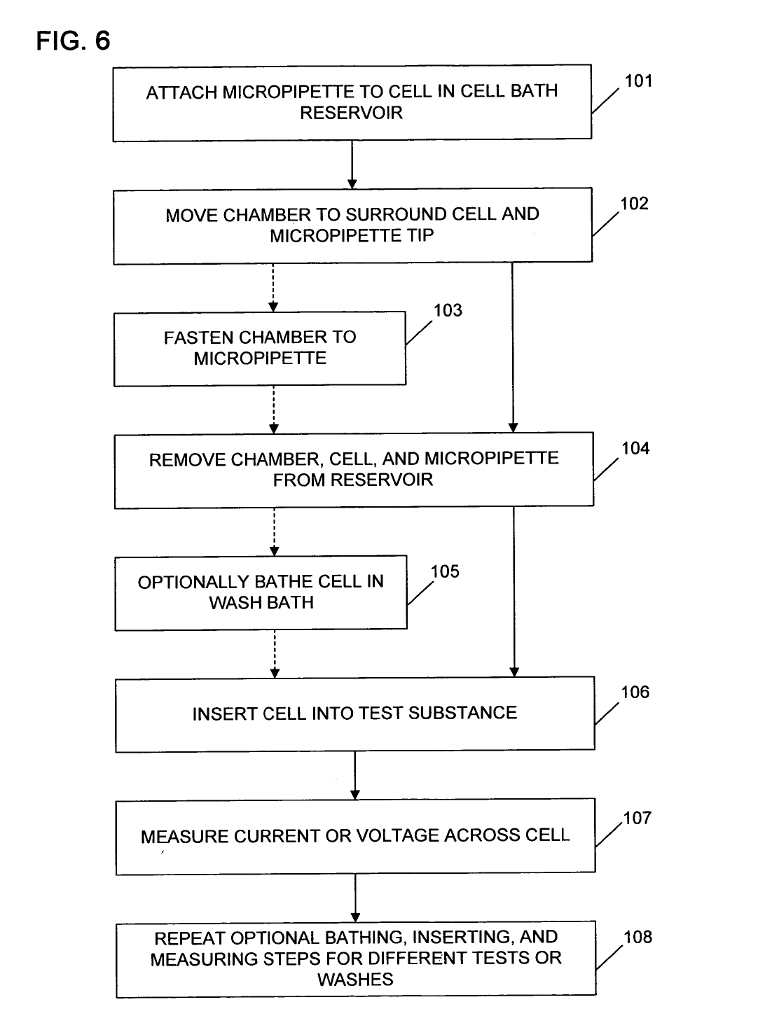

FIG. 6 illustrates a flow chart showing a preferred method of using the interface system 7 of FIGS. 1 and 3 in accordance with an embodiment of the invention.

In step 101, shown in FIG. 1A, the capillary tip 2a is attached to the cell membrane 10a of a cell 10. The cell 10 may be in a liquid bath 12 at the time of attachment. The attachment may occur in any manner that capillaries can be attached to cells, which may involve a slight suction and voltage to seal the capillary tip 2a to the cell 10. The capillary 2 is preferably affixed to the cell 10 in such a manner that the capillary tip 2a covers one or more protein ion channels of the cell membrane 10a. More preferably, the patch of cell membrane 10a within the capillary tip 2a is ruptured by stronger suction and/or voltage to form a whole cell patch recording of the entire cell membrane 10a. The capillary 2 preferably comprises an electrode 4. The interface chamber 6 preferably comprises a coil-shaped electrode. During this step, the interface chamber 6 may enclose the capillary 2 in a position remote from the capillary tip 2a.

In step 102, the capillary 2 and the interface chamber 6 are moved relative to each other so that the interface chamber 6 encloses the capillary tip 2a and the cell 10 affixed to it. This may be accomplished by moving a rod 8 coupled to the interface chamber 6 so that the interface chamber 6 moves along the axis of the capillary 2 toward the capillary tip 2a, or by moving the capillary 2 such that the capillary tip 2a and cell 10 are enclosed by the interface chamber 6. The interface system 7 is formed when the interface chamber 6 encloses the capillary tip 2a and the cell 10.

In optional step 103, the capillary 2 (or capillary holder) and interface chamber 6 are fastened together with a fastener 22 so that they can be easily moved together with little or no relative movement. Alternately, in this step 103 the fastener 22 may be used to couple the capillary 2 directly to the interface chamber 6. In this event, the fastener 22 preferably comprises a non-conductive material to avoid affecting the electrical properties of the interface chamber 6.

In step 104, the interface system 7 is removed from the liquid bath 12, and in the process preferably removes and suspends a portion of the liquid bath 12. It should be noted that the interface system 7 is moved as a composite whole; the system 7 components may be fastened together to facilitate moving them as a system 7 (as described in optional step 103), or the components can be moved together at the same time in order to move them as a system 7. The small volume of liquid 26 suspended in the cavity of the interface chamber 6 is the interface bath 26, and it continually surrounds the cell 10. The capillary forces and/or surface tension of the interface bath 26 preferably keep the liquid from leaking out through any gaps or holes in the interface chamber 6. For instance, if the interface chamber 6 has the shape of a coil, the surface tension of the interface bath 26 will prevent it from leaking through the tinges of the coil. In a preferred embodiment, the capillary tip 2a will stay in a fixed position relative to the interface chamber 6 and the interface bath 26 as the capillary 2 and cell 10 are removed from the bath 12.

In optional step 105, the cell 10 is washed. This step may comprise inserting the interface system 7 into a washing liquid, such as a neutral aqueous solution. The washing liquid preferably does not contain any active ingredients or test drugs. Rather, the washing liquid rinses the cell 10. The washing liquid may also clean or replace the liquid suspended in the interface chamber 6. This washing step may occur any time the cell 10 needs to be washed as the process requires; for instance, the cell 10 may be washed after it is immersed in solution comprising a test compound 20. Preferably the washing solution is located in a reservoir 18 of a plate 16.

In step 106, the cell 10 is inserted into a reservoir 18. The reservoir 18 preferably comprises a test solution, for example a candidate drug 20.

In step 107, current and/or voltage is measured across the electrode 4 and cell membrane 10a.

In optional step 108, the interface system 7 is withdrawn from the reservoir 18 and optionally washed, as described in step 105.

In optional step 109, the interface system 7 is inserted into another reservoir 18, and the measuring process is repeated (optionally with washing step 105) for a number of reservoirs 18. Preferably, each reservoir 18 comprises a different concentration of the same drug, or alternately, the reservoirs 18 may contain different drugs in the same or different concentrations. One advantage of using the interface chamber 6 comprising an electrode is that it maximizes the efficiency of drug diffusion to the cellular membrane 10a because of the small volume of solution contained in the interface chamber 6. The same reference electrode is used, and capacitance of the patch pipette remains the same with solution changes, which maintains the accuracy of recordings.

### EXAMPLES

### Example 1

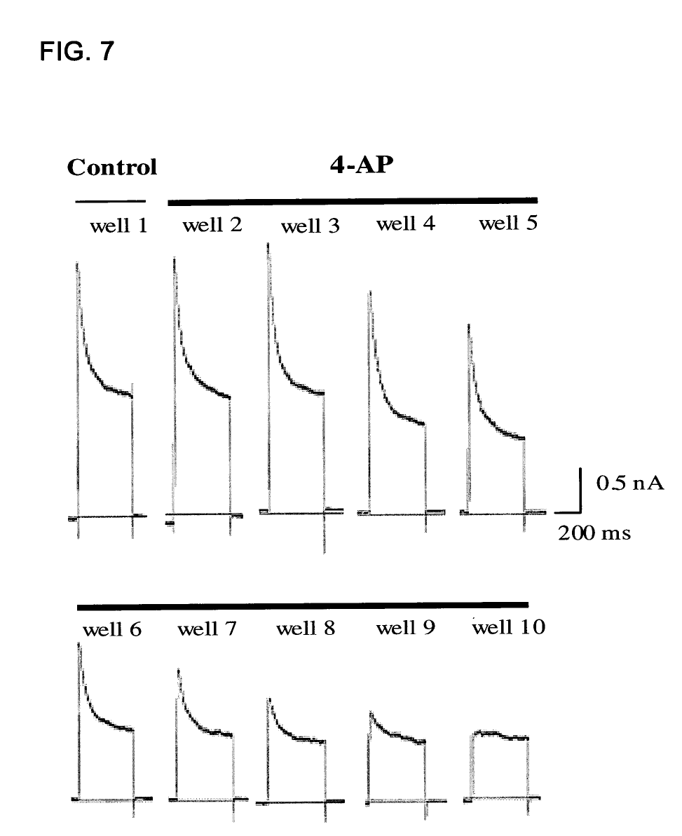

FIG. 7 shows the effect of nine 4-AP concentrations on outward potassium currents in DRG neurons according to one example of the invention. The current across a patch clamp measuring electrode and cell versus time is shown. Whole cell recording measurements were obtained via conventional methods. The interface chamber was moved to surround the cell as in steps 101-103 above. A measurement of current was recorded while the cell was in a well containing a normal saline (control) solution. The cell was then moved from normal saline to a well containing increasing concentrations (from 0 to 10 mM in increasing increments) of the K⁺ channel blocker 4-AP. For each of the measurements, cells were held at −50 mV, stepped with a prepulse to −100 mV for 400 ms and then stepped for the test to +40 mV. After the test pulse, cells were repolarized to −60 mV. Sweeps were obtained every 10 sec, and 5 sweeps were obtained per well. The interface was moved from one well to the next in a short time, such as 2 seconds.

Outward currents due to K⁺ flow from the cell is shown. At the highest concentration tested, no inactivating current remains, while significant non-inactivating (persistent) current persists. As shown, increasing concentrations of the K⁺ channel blocker 4-AP decreased the current across the cell membrane. The lower current is consistent with the expected blocking effected of the 4-AP. Both the peak current (the spike at the left of graph of each measurement) and the end current (final value of current for each measurement) decreased as the concentration of 4-AP increased.

### Example 2

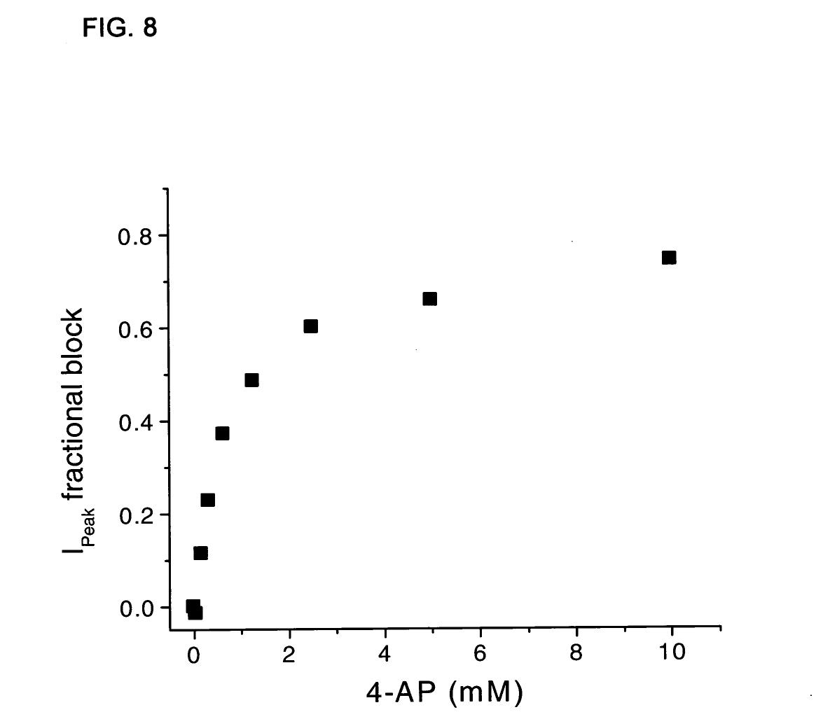

FIG. 8 illustrates a graph showing the peak current of a fractional block versus the concentration of a test substance according to one example of the invention. In FIG. 8 the peak current from Example 1 (FIG. 7) is displayed as a fractional block versus the concentration of the test substance 4-AP. As shown, the peak current decreased as the concentration of 4-AP increased, as predicted. The dose response curve shown illustrates the ability of this system to measure multiple concentrations of test substance accurately.

### Example 3

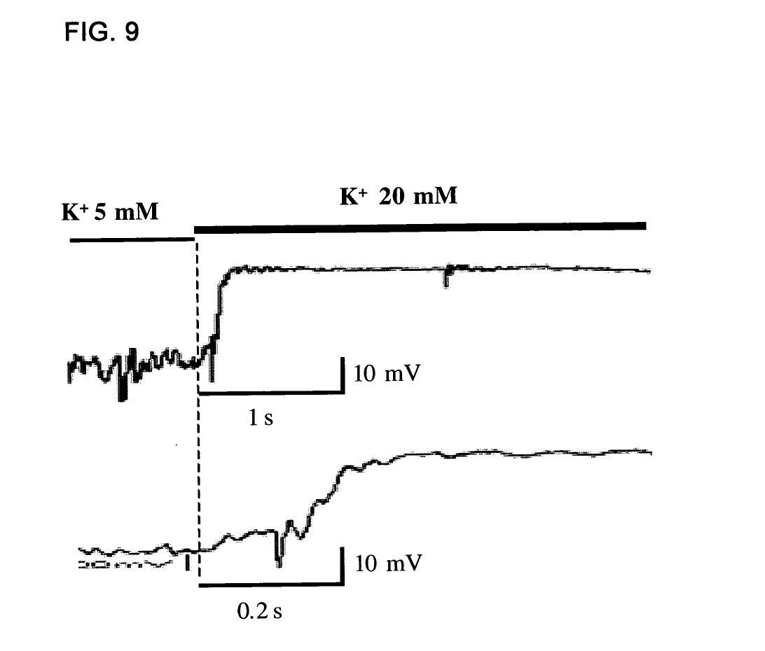

FIG. 9 shows the measurement of the voltage change across a patch clamp measuring electrode versus time according to one example of the invention. A recording is obtained from a CHO cell membrane in the whole cell configuration. The interface chamber is moved around the cell and fastened to the electrode (steps 102 and 103). The cell is moved from 5 mM KCl into 20 mM KCl during the recording. This action changes the voltage across the membrane due to a potassium gradient jump. As shown, the voltage reached a steady state within approximately 0.2 seconds, which is a faster response time (i.e. solution exchange) than is available using prior art systems and methods designed for screening.

### Example 4

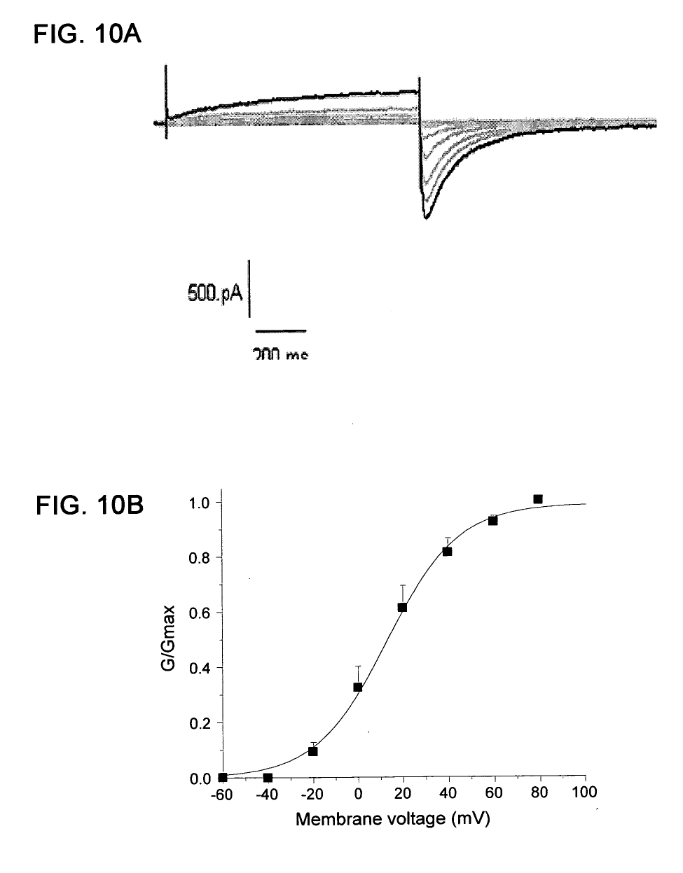

FIGS. 10A-10B illustrate a graph showing ion channel current measurements obtained using an embodiment of the invention. In this example, a cell was attached to a pipette according to the method shown in FIGS. 2A-2C. In FIG. 10A, representative recordings are shown for ion currents obtained from HEK293 cells stably expressing hERG channels. Cells were kept at −80 mV. Outward potassium currents were elicited by 1-sec long test voltages ranging from −60 to 80 mV in steps of 20 mV followed by a 1-sec long hyperpolarizing pulse to −100 mV. The sweep to sweep interval time was 10 seconds. In FIG. 10B, a G/Gmax (conductance/maximal conductance) curve is shown for hERG channels. The data represents mean±SD, where the number of sample measurements is 7.

### Example 5

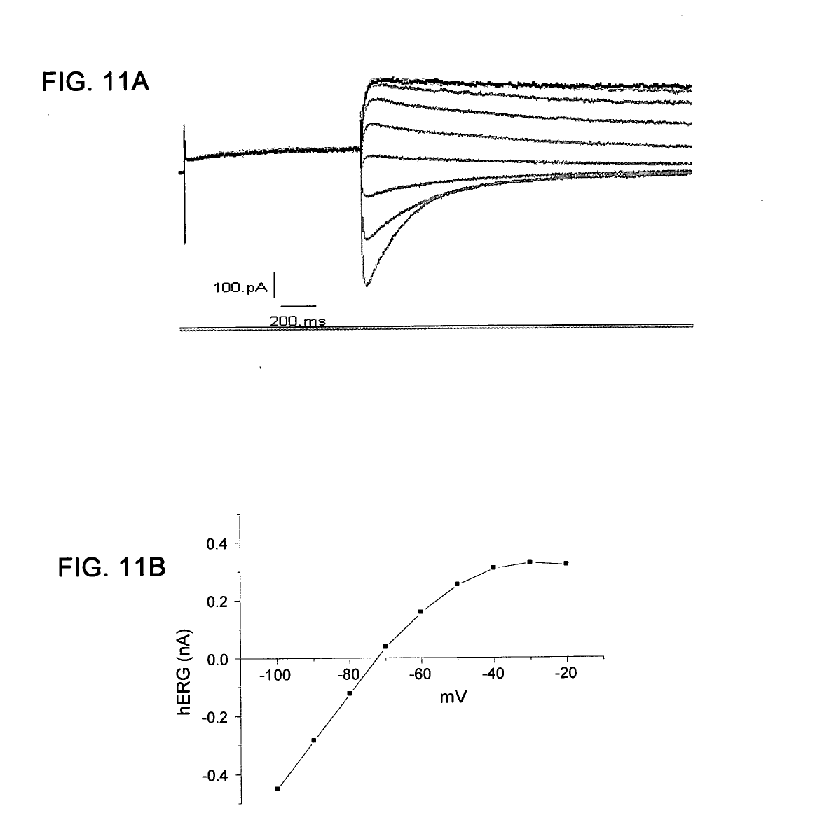

FIGS. 11A-11B illustrate a graph showing ion currents obtained from HEK293 cells stably expressing hERG channels. In this example, a cell was attached to a pipette according to the method shown in FIGS. 2A-2C. In FIG. 11A, current traces are shown. In FIG. 11B, a corresponding tail current current-voltage curve is shown. In obtaining these measurements, the cell was kept at −80 mV. Outward potassium currents were elicited by 1-sec long test voltages to +40 mV followed by 2-second long hyperpolarizing pulses ranging between −100 mV and −20 mV in steps of 10 mV. The sweep to sweep time interval for these measurements was 10 seconds.

### Example 6

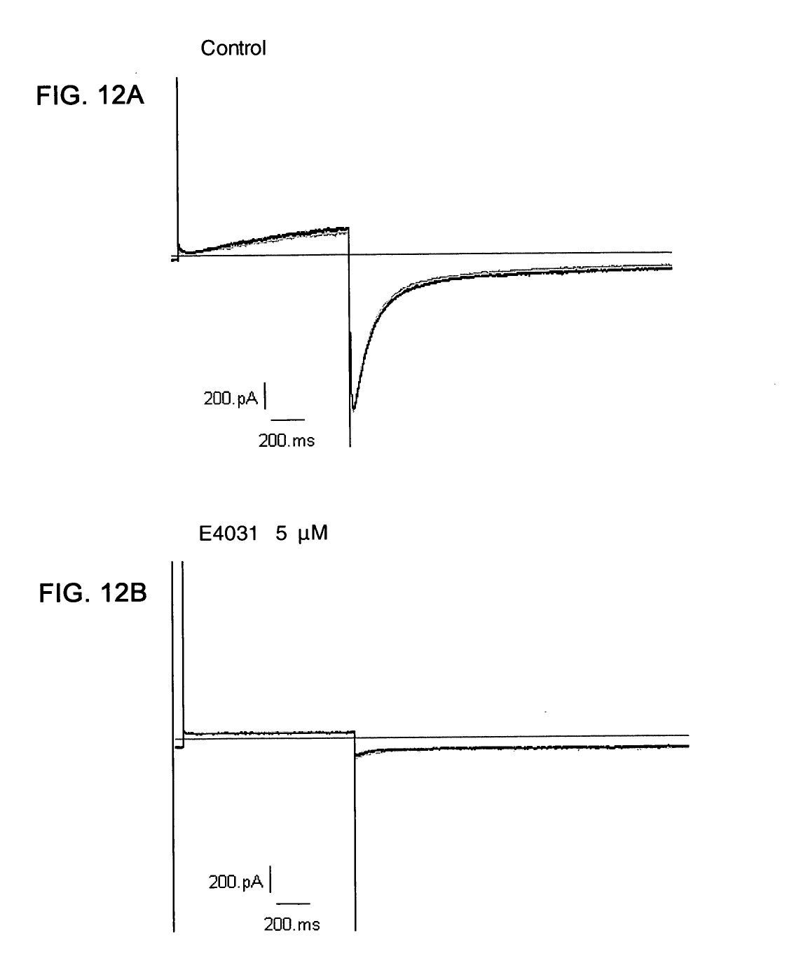

FIGS. 12A-12B illustrate a graph showing the effect of E4031 on potassium current in HEK293 cells stably expressing hERG channels. In this example, a cell was attached to a pipette according to the method shown in FIGS. 2A-2C. In FIG. 12A, current traces are shown for a control cell. In FIG. 12B, current traces are shown for a cell after application of 5 micromole solution of E4031. The cell was kept at −80 mV. Outward potassium currents were elicited by 1-second long test voltages to +40 mV followed by 2-sec long hyperpolarizing pulses to −100 mV applied at 0.1 Hz.

### Example 7

Data may also be obtained by one skilled in the art from ligand-gated channels with methods similar to those above. Ligand concentrations sufficient to open the channels under study may be added to a well, and upon insertion of a cell into the well, ion currents are obtained. Data traces may look very similar to those in example 3 for a channel with fast gating kinetics. This technique would be applicable to any ligand-gated channel, including channels responsive to glutamate, GABA, and acetylcholine.

It will be understood that the specific embodiments of the invention shown and described herein are exemplary only. Numerous variations, changes, substitutions and equivalents will occur to those skilled in the art without departing from the spirit and scope of the invention. In particular, the terms used in this application should be read broadly in light of similar terms used in the related applications. Further, it should be recognized that it is within the skill of one in the art to use various features from one described embodiment with features from another embodiment. Accordingly, it is intended that all subject matter described herein and shown in the accompanying drawings be regarded as illustrative only and not in a limiting sense and that the scope of the invention be solely determined by the appended claims.

1. A system comprising an interface chamber, wherein said interface chamber provides an interface bath capable of suspending a cell.

2. The system of claim 1, further comprising a pipette comprising an electrode coupled to said cell.

3. The system of claim 3, wherein said interface chamber is an electrode.

4. An interface system, comprising an interface chamber, wherein a cell is coupled to a capillary at a gigaseal interface, and wherein said interface chamber and capillary are relatively movable so that the capillary can slide through the interface chamber, said interface chamber being suitable for suspending a liquid.

5. The system of claim 4, wherein said micropipette comprises an electrode.

6. The system of claim 5, wherein said interface chamber is an electrode.

7. The system of claim 6, wherein a rod is coupled to said interface chamber.

8. The system of claim 6, wherein said interface chamber is substantially cylindrical in shape.

9. The system of claim 6, wherein said interface chamber is a coil.

10. The system of claim 6, wherein said interface chamber is suitable for suspending liquid that has a volume not greater than 100 uL.

11. The system of claim 6, wherein said cell is a mammalian cell.

12. The system of claim 6, further comprising a device for measuring at least one of current and voltage between said electrodes.

13. The system of claim 12, further comprising a recording means for recording at least one of a voltage and current measured by at least one of the interface chamber electrode and the capillary electrode.

14. A patch clamp system, comprising:
a) a capillary comprising an electrode;
b) a cell coupled to said capillary in a manner sufficient to form a gigaseal between the capillary and the cell membrane of said cell;
c) an interface chamber comprising an electrode, wherein said interface chamber and capillary are relatively movable so that the capillary can slide through the interface chamber, said interface chamber being suitably shaped to contain and suspend a liquid;
d) a device for measuring at least one of current and voltage between said electrodes; and
e) a plate comprising a plurality of reservoirs, wherein at least one reservoir comprises a test compound.

15. A method of measuring the properties of a cell, comprising:
a) placing a cell in an interface chamber, wherein said interface chamber suspends said cell in an interface bath, and wherein said cell is affixed to a capillary; and
b) measuring one or more properties of the cell.

16. A method of measuring properties of a cell, comprising:
a) placing a cell in an interface chamber, wherein said cell is affixed to a capillary through a gigaseal, and wherein said interface chamber and capillary are relatively movable so that the capillary can slide through the interface chamber; and
b) measuring one or more properties of the cell.

17. The method of claim 16, wherein said interface chamber is an electrode.

18. The method of claim 17, wherein said interface chamber electrode and micropipette electrode are configured to measure current across the cell's membrane.

19. The method of claim 17, wherein said interface chamber is coupled to a rod, further comprising using the rod to move the interface chamber along the axis of the capillary.

20. The method of claim 17, wherein said cell is a mammalian cell.

21. The method of claim 17, further comprising:
a) transferring said interface system to a reservoir, wherein the reservoir comprises a solution of test compound; and
b) measuring the electrical current flowing across the cell membrane.

22. The method of claim 21, wherein the solution of test compound has a volume of less than 350 uL.

23. The method of claim 21, wherein said reservoir is one of a plurality of reservoirs disposed on a plate.

24. The method of claim 23, wherein said plurality of reservoirs contains one or more different test compounds.

25. The method of claim 24, further comprising repeating said transferring and measuring steps for said plurality of reservoirs, wherein said interface system is transferred to a different reservoir before each measuring step.

26. The method of claim 25, wherein the interface system is washed before at least one transferring step.

27. The method of claim 21, wherein one or more steps is automated.

28. The method of claim 16, further comprising measuring current across one or more ligand-gated channels in the cell membrane.

29. The method of claim 28, wherein the ligand-gated channel is responsive to a compound selected from the group consisting of glutamate, GABA, and acetylcholine.

30. The method of claim 16, further comprising measuring current across one or more voltage-gated channels in the cell membrane.

31. A method of measuring the properties of a cell, comprising:
a) establishing an interface system, comprising an interface chamber, wherein a cell is affixed to a capillary in a manner sufficient to form a seal between the capillary and the cell, and wherein said interface chamber and capillary are relatively movable so that the capillary can slide through the interface chamber, said interface chamber being suitably shaped to contain and suspend a liquid;
b) establishing a means for measuring at least one of current and voltage between said electrodes;
c) transferring the interface system to a first reservoir comprising a test compound; and
d) measuring the electrical current flowing across the cell membrane.

32. The method of claim 31, further comprising repeating the transferring and measuring steps for one or more different reservoirs, wherein the interface system is transferred to a different reservoir before every measuring step.

33. The method of claim 32, wherein the uncompensated capacitance of the capillary electrode remains substantially the same during the time period when the interface chamber is transferred from one reservoir to another reservoir.

34. A method of attaching a cell to a capillary, comprising:
a) applying positive pressure inside the capillary;
b) inserting the capillary into a dense layer of cells, wherein said capillary is inserted at a depth appropriate for attaching a cell to the capillary without breaking the capillary tip; and
c) decreasing the pressure inside the capillary to form a gigaseal between the capillary and the cell.

35. The method of claim 34, further comprising:
a) removing the capillary from the layer of cells; and
b) further decreasing the pressure inside the capillary to establish a whole cell configuration for the cell.

36. A method of attaching a cell to a capillary, comprising:
a) applying positive pressure of about 900-1000 mm Hg (absolute) inside the capillary;
b) inserting the capillary into a dense layer of cells;
c) decreasing the pressure inside the capillary to about 700 mm Hg to form a gigaseal between the capillary and a cell;
d) removing the capillary from the layer of cells; and
e) further decreasing the pressure inside the capillary to about 600-650 mm Hg to establish a whole cell configuration for the cell.

37. A method of measuring the properties of a cell, comprising:
a) placing a cell in an interface chamber, wherein said interface chamber suspends said cell in an interface bath in the interface chamber, and wherein said cell is affixed to a capillary according to the method of claims 34 or 35; and
b) measuring one or more properties of the cell.
